(19) United States
(12) Patent Application Publication
(10) Pub. No.: US 2015/0353117 A1
(43) Pub. Date: Dec. 10, 2015

(54) Ski Bike

(71) Applicant: Robin Peng, Sandy, UT (US)

(72) Inventor: Robin Peng, Sandy, UT (US)

(21) Appl. No.: 14/590,871

(22) Filed: Jan. 6, 2015

Related U.S. Application Data
(60) Provisional application No. 61/924,033, filed on Jan. 6, 2014.

(51) Int. Cl. B62B 13/06; B62B 17/06

(52) U.S. Cl. CPC B62B 13/06; B62B 17/062

(57) ABSTRACT

A ski bike for recreation is disclosed. The ski bike features a frame with forward and rearward skis with improved foot mountings. The foot mountings are canted so that the rider is in a forward position over the bike's handlebars. The degree of cant is adjustable and provided stomp plates are modular for different terrain and environment. Adjustable foot bindings are also provided.

### CROSS-REFERENCES TO RELATED APPLICATIONS

This Application claims priority as a non-provisional perfection of prior filed U.S. application Ser. No. 61/924,033, filed Jan. 6, 2014, and incorporates the same herein in its entirety.

### FIELD OF THE INVENTION

The present invention relates to the field of runner vehicles and more particularly relates to an occupant steered ski bike.

### BACKGROUND OF THE INVENTION

A ski bike is a framed vehicle, similar to a bicycle or tricycle, with two or three runners and which is used to traverse snow-covered terrain. Ski bikes have been known in the art for about 50 years and have begun to gain a respectable following. Ski bikes offer many advantages over traditional skis and snow boards in that they are easier to handle and their design provides a more stable vehicle for use in winter activities. They also are operated in a manner similar to snow skis. As such, they are used by beginning skiers as a training aid and by injured, disabled or older individuals as a means to participate in outdoor activities. Ski bikes are also used by traditional skiers and snowboarders as a more relaxed and safer activity.

The first ski bikes were, essentially, bicycles converted for use on snow and their current evolution reflects this heritage. While many companies design and manufacture ski bikes, there are some improvements which can be made to the design. The ski bike may be made more responsive to the rider, allowing for more freedom of movement and easier control. In so doing, the ski bike may be made easier for novices and those with mobility issues. Safety may also be improved.

The present invention represents a departure from the prior art in that the ski bike of the present invention allows for improved handling and safety over the prior art, in particular with improvements in the foot interfaces with the ski bike.

### SUMMARY OF THE INVENTION

In view of the foregoing disadvantages inherent in the known types of ski bikes, this invention provides an improved ski bike that is easier to handle and is more responsive to terrain irregularities. To accomplish these objectives, the ski bike comprises a number of new features, including a divided frame with a suspension component, a modular stomp plate with options for various seasons or activities, an adjustable cant plate to force weight distribution of the rider forward, a self-recovering and self-righting suspension, and a twist-retarding handlebar assembly.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an exemplary ski bike according to the present invention.

FIGS. 2-5 are various views depicting the divided frame of the ski bike and multi-axial suspension and recovery device joining the frames portions.

FIG. 6 is a perspective view of a rear foot support of the ski bike of FIG. 1, showing modular stomp plates.

FIG. 7 is a side elevation of the foot support of FIG. 6, depicting the cant plate.

FIG. 8 is a perspective view of the foot support of FIG. 6, depicting use of the lateral binding.

FIG. 9 is a front elevation of both foot supports, depicting use of the lateral bindings.

FIG. 10 is a perspective view of the swing arm component of the self-recovering suspension.

FIG. 11 is an exploded view of the swing arm of FIG. 10.

FIG. 12 is a perspective view depicting the rotationally restricted handle bar assembly.

FIG. 13 is an exploded view of an alternate lateral binding and stomp plate embodiment.

FIG. 14 is a side elevation of the lateral binding of FIG. 13 in a rearward adjustment.

FIG. 15 is a side elevation of the lateral binding of FIG. 13 in a forward adjustment.

FIG. 16 is a side elevation of the binding component of the lateral binding of FIG. 13 at a low height adjustment.

FIG. 17 is a side elevation of the binding component of the lateral binding of FIG. 13 at a high height adjustment.

### DETAILED DESCRIPTION OF THE PREFERRED EMBODIMENT

With reference now to the drawings, the preferred embodiment of the ski bike is herein described. It should be noted that the articles “a”, “an”, and “the”, as used in this specification, include plural referents unless the content clearly dictates otherwise.

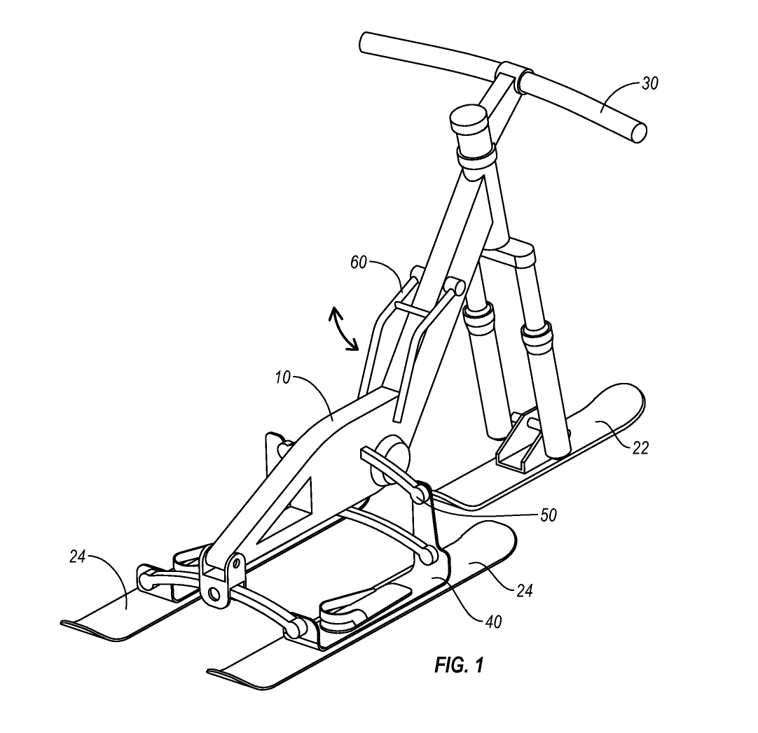

With reference to FIG. 1, the ski bike has the basic components of a known ski bike. That is to say it is a frame 10 mounted on a plurality of skis 22, 24. It features a handle bar 30 and, as the depicted ski bike has three skis, a foot mounting 40 over each of the back two skis 20.

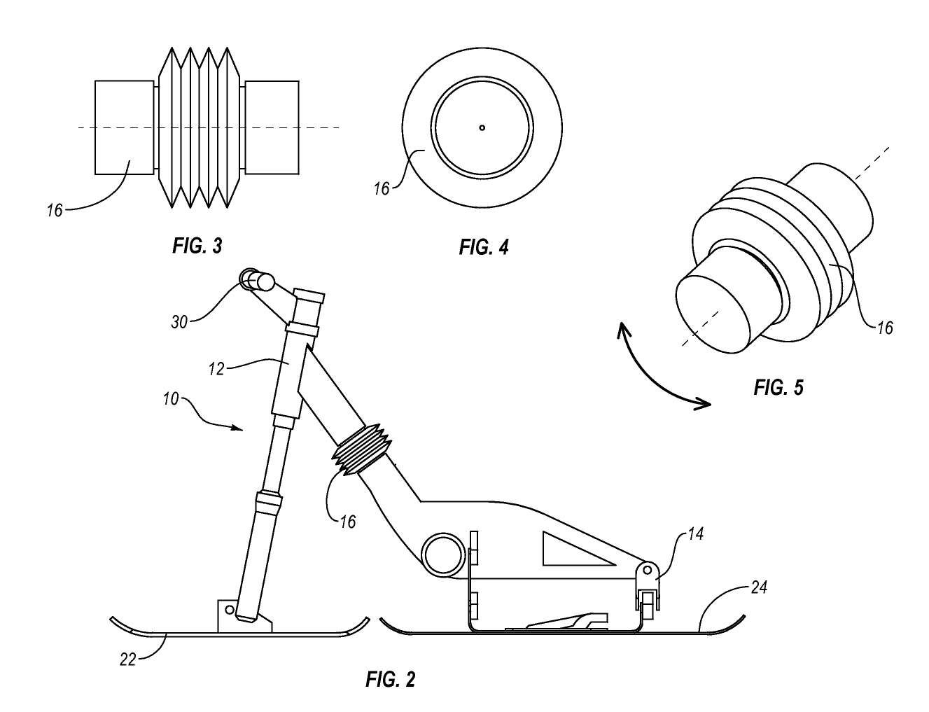

The improvements in the present invention are many. The divided frame 10 is split into two sections 12, 14, as shown in FIG. 2. These sections are joined by a rubberized dampener module 16. The module 16, shown in FIGS. 3-5, is optimized to allow flexion along all axes. By allowing such flexion, the frame 10 is adaptive to most terrain situations that a user may encounter, while lessening any shock that a user may experience. The flexion also allows for the frame to move in the course of performing areal tricks. This module 16 tends to then receive the bulk of abuse and shock caused by terrain irregularities. It may, of course, be replaced when worn or damaged. Alternative embodiments may provide adjustable resistance, as controlled by a dial (shown in FIG. 1).

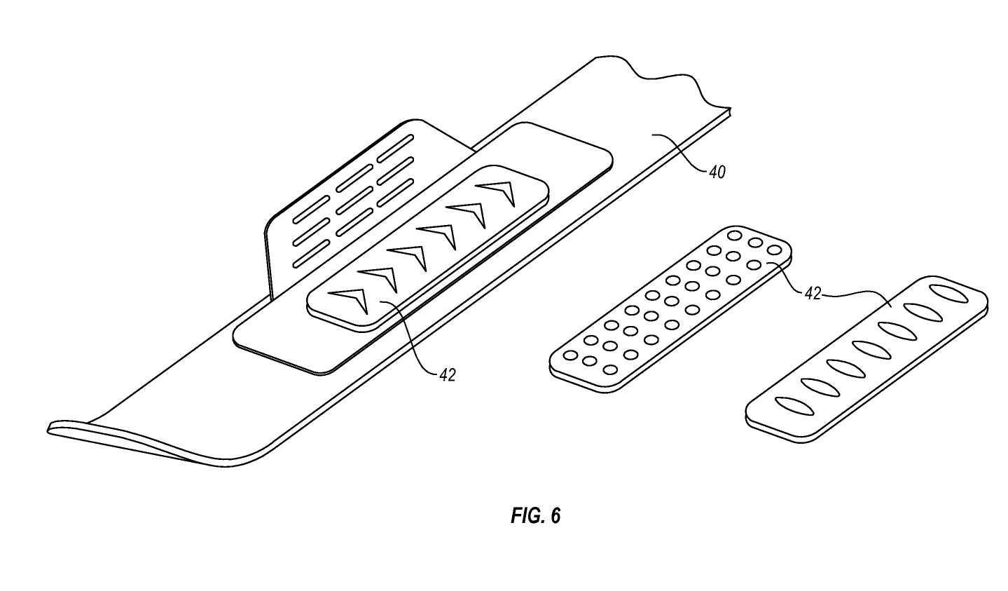

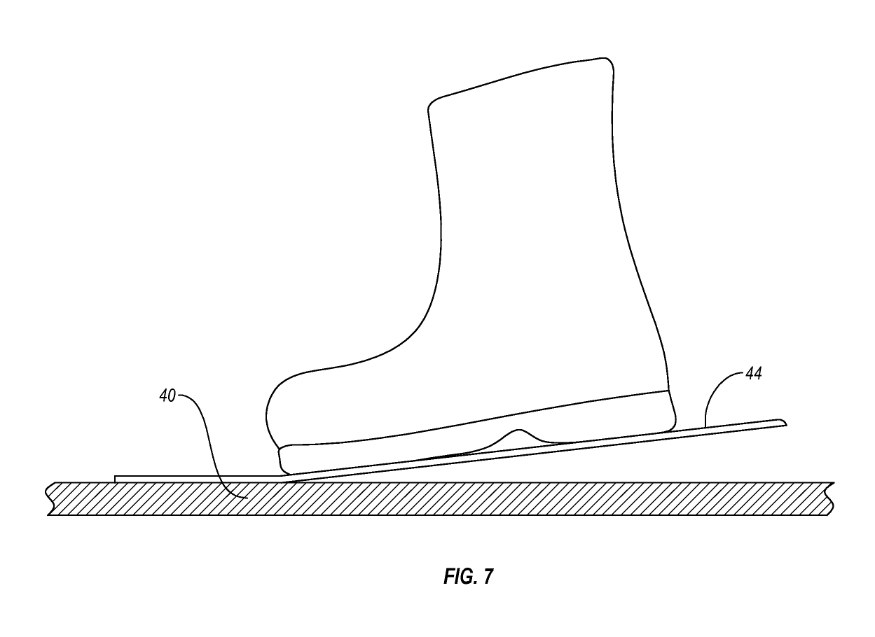

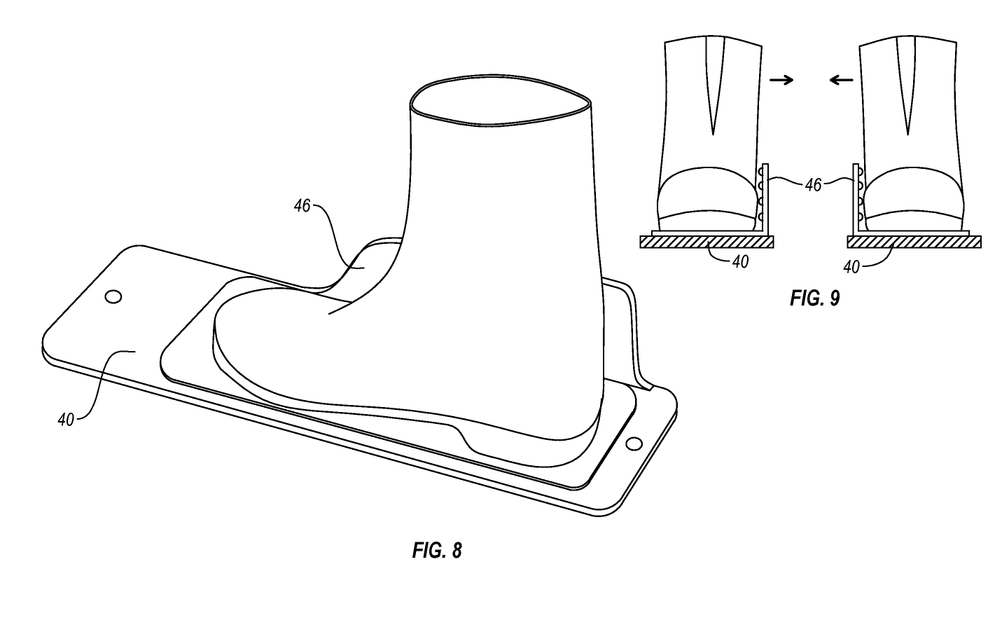

As one feature common in ski bikes is the ability to transform the bike from a ski bike to a regular wheeled bicycle for use in warmer temperatures. To aid in this conversion, the stomp plates 42, mounted over the foot mountings 40, are modular, shown in FIG. 6. Various module designs may be developed for winter, summer, or other use. These stomp plates 42 are, in turn, mounted over a cant plate 44, shown in FIG. 7. The purpose of the cant plate 44 is to angle the positioning of the user forward. When a user places too much of their weight towards the rear of the ski bike, the ski bike becomes more difficult to control and the weight distribution tends to unevenly distribute the hind portion of the bike. This distribution also tends to contribute to injuries of the user. By forcing the user forwards, the distribution of weight over the bike 10 is more even between the front and the back. As a result, it is easier to control the bike 10, especially when areal tricks are performed or when terrain becomes more difficult. Injuries also tend to be lessened in occurrence and severity due to the positioning of the user in a more forward position. The cant plate 44 may be removed and replaced with cant plates of different angles for customization. A further development in the foot mounting is the side bindings 46 positioned by the stomp plates 42 (FIGS. 8 and 9). These vertical side bindings 46 allow the user to grasp the rear portion of the bike frame 10 between their feet and allow for even greater lateral control of the ski bike. The side bindings include a friction surface to facilitate gripping.

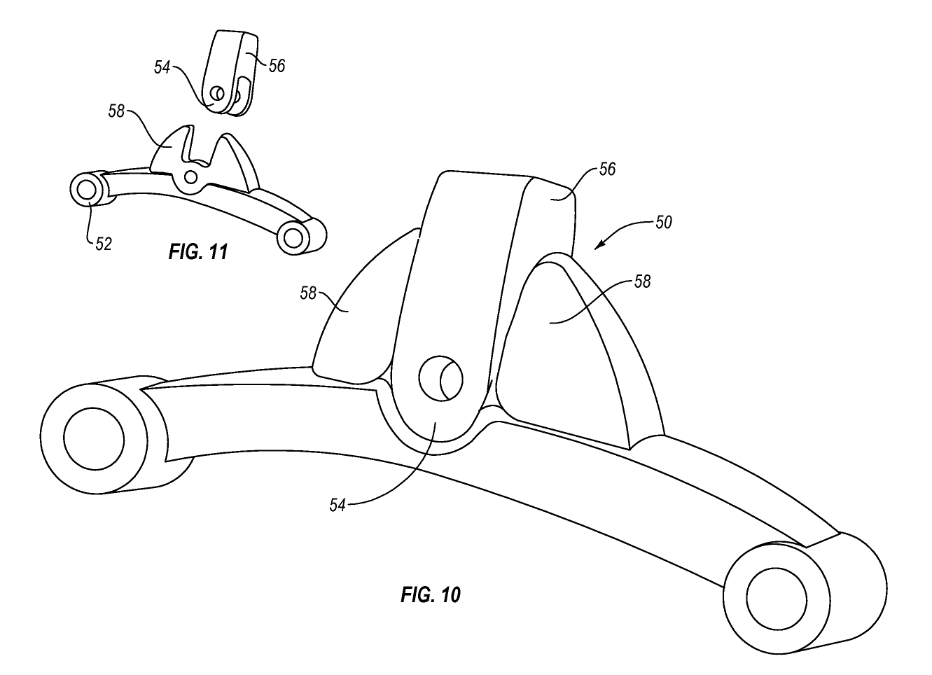

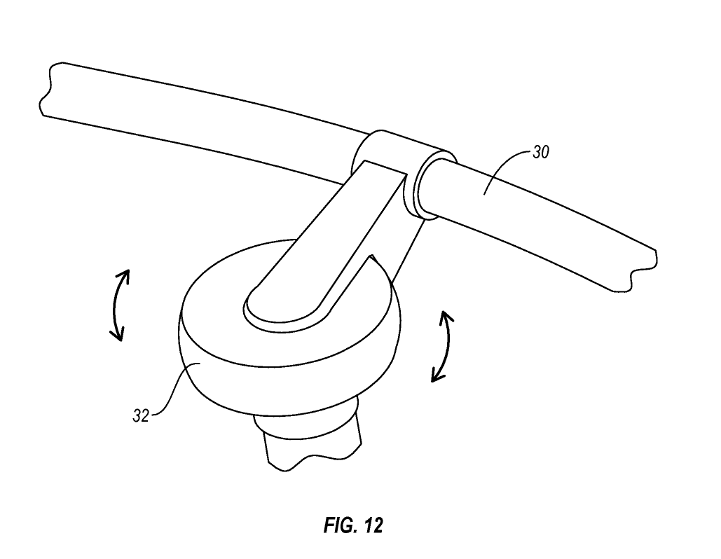

Further improvement is found in the self-recovering swing arm assembly 50 as a part of the suspension system of the ski bike 10 (FIGS. 10 and 11). The swing arm allows the ski bike to flex in a side-to-side manner while being ridden. The arm 52 straddles the bike frame 10 and connects to the two rear skis 24 (FIG. 1). The arm connects to the frame with a pivoting hinge 54 at a provided upper control arm 56. Two triangular compressible bushings 58 are positioned on either side of the pivoting hinge 54 and control arm 56. When a rider tilts the ski bike, the control arm 56 and swing arm 52 will rotate with respect to one another such that the angle between them on one side or the other will lessen. This will them compress one or the other of the bushings 58. Not only will the bushing 58 then cushion the tilt and prevent the two pieces from colliding, but it will serve to provide a restorative force to the two arms and aid in self-alignment of the ski bike 10. The use of multiple swing arm assemblies is recommended, as is shown in FIG. 1.

The handlebar 30 is provided primarily for support of the rider—its use is not intended for primary steering. Ideally, the rider will utilize tilt of the ski bike in order to ski, as is the method by which traditional skiers use to turn their bodies as they ski. However, it is common practice on a ski bike that novices will instinctively try to turn by turning the handlebar in an effort to turn front ski 22 (FIG. 2). A bushing 32 is provided to provide an increasing resistance and restorative force to the handlebar 30 should a rider attempt to turn the handlebar 30. While it may be advantageous to fix the handlebar 30 in relation to the frame, avoiding the issue of turning entirely, providing some give in the handlebar 30 does allow for greater flexion and responsiveness to terrain. Like the dampener module 16, the handlebar bushing 32 is replaceable. A handlebar 30 is provided due to the familiarity of the structure to new users. It is entirely conceivable that some other means of rider support could be utilized and still fall within the purview of the invention.

Additionally, a foldable ski lift hook 60 is provided to the frame 10 (FIG. 1). The hook 60 may be deployed to interface with a ski lift and folded during use. In use, the hook 60 may double as a seat for the rider during a break.

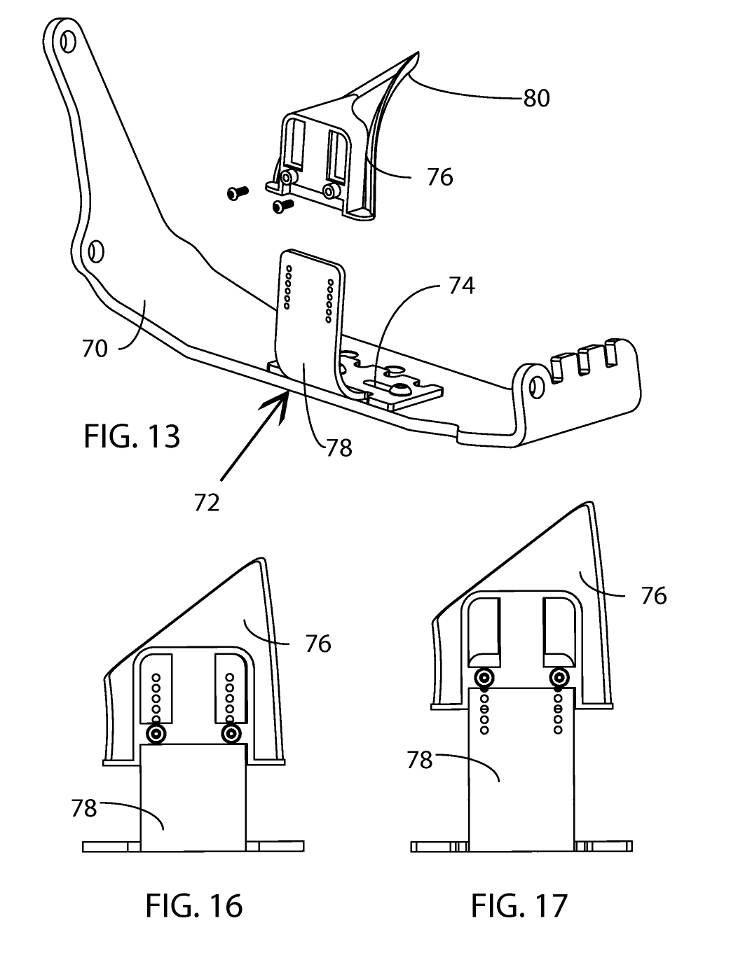

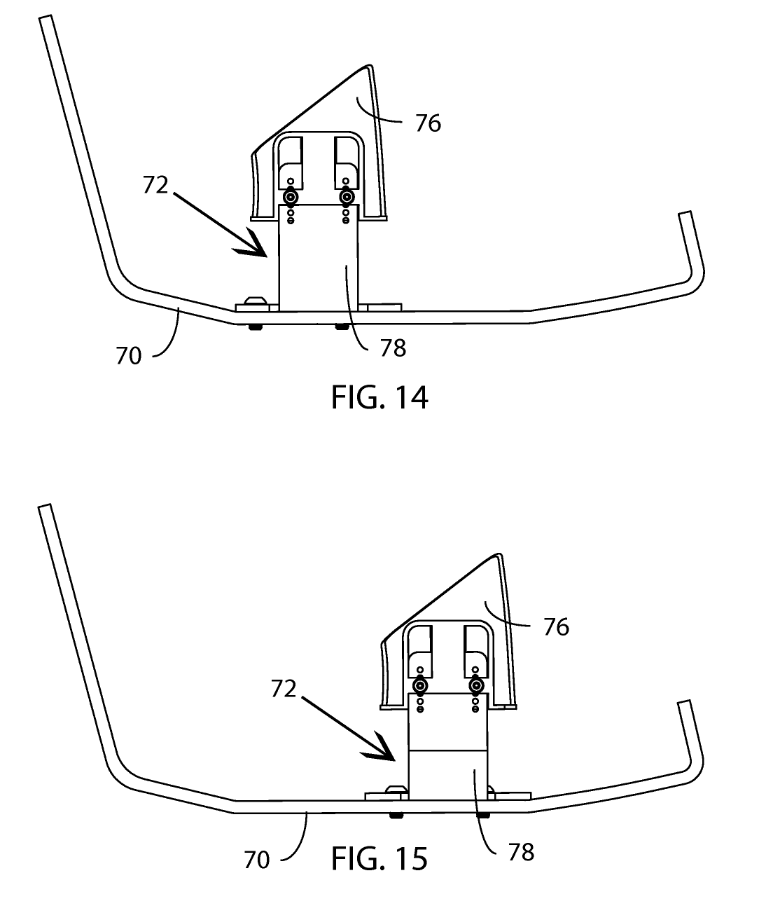

Further improvements are found in an alternate embodiment of the foot mountings (FIGS. 13-17). Alternate stomp plate 70 is fitted with a removable side binding 72 (FIG. 13) projecting relatively orthogonally from the surface of the stomp plate 70. Side binding 72 features lateral slots 74 which allow for variable rearward (FIG. 14) and forward (FIG. 15) positioning on the stomp plate 70. It should be noted that height adjustment in the side binding 72 is accomplished by forming side binding 72 from upper 76 and lower 78 pieces (FIGS. 16 & 17). As shown, adjustment of the upper 76 and lower 78 pieces may be accomplished by a set of vertically related pairs of holes into which bolts, passing through upper piece 76, may be threaded. It should also be noticed that a hook 80 may be provided the upper piece 76 to aid in user interface. Together these adjustment features allow for a wide array of user customization for different sizes of boots and stances on the ski bike, thereby increasing comfort, controllability and, ultimately, safety of the ski bike for the user. This construction of the alternate foot mountings may be accomplished by a modified stomp plate, as shown, or by modifying a cant plate or by an intermediate plate positioned between the cant plate and stomp plate.

Although the present invention has been described with reference to preferred embodiments, numerous modifications and variations can be made and still the result will come within the scope of the invention. As a non-limiting example, the ski bike may be manufactured with a single rear ski as opposed to the two rear skis as depicted and preferred. No limitation with respect to the specific embodiments disclosed herein intended or should be inferred.

What is claimed is:

1. A ski bike comprising:
a. a frame;
b. at least one front ski attached to the frame;
c. a means of rider support positioned on the frame over the at least one ski;
d. at least one rear ski attached to the frame;
e. at least one foot mounting with a canted stomp plate, one located on each of the at least one rear ski.

2. The ski bike of claim 1, the stomp plate being removable and canted forward by a cant plate.

3. The ski bike of claim 2, the at least one foot mounting further comprising at least one foot binding projecting relatively orthogonal from a surface of the foot binding.

4. The ski bike of claim 3, the at least one side binding being removable from the foot mounting and adjustable in its relative position to the foot mounting.

5. The ski bike of claim 4, the at least one side binding being comprised of a lower side binding and an upper side binding, the upper and lower side bindings being movable in relation to each other so as to effect height adjustment.

6. The ski bike of claim 5, the upper side binding being hooked to catch a user's boot.

7. The ski bike of claim 4, the side binding being hooked to catch a user's boot.

8. The ski bike of claim 3, the side binding being hooked to catch a user's boot.

9. The ski bike of claim 1, the at least one foot mounting further comprising at least one side binding projecting relatively orthogonal from a surface of the foot binding.

10. The ski bike of claim 9, the at least one side binding being removable from the foot mounting and adjustable in its relative position to the foot mounting.

11. The ski bike of claim 10, the at least one side binding being comprised of a lower side binding and an upper side binding, the upper and lower side bindings being movable in relation to each other so as to effect height adjustment.

12. The ski bike of claim 11, the upper side binding being hooked to catch a user's boot.

13. The ski bike of claim 10, the side binding being hooked to catch a user's boot.

14. The ski bike of claim 9, the side binding being hooked to catch a user's boot.
